(19) United States
(12) Patent Application Publication
(10) Pub. No.: US 2004/0154093 A1
(43) Pub. Date: Aug. 12, 2004

(54) Portable sauna

(76) Inventor: Aijaz Akhtar, Oxford (GB)

Correspondence Address: YOUNG & THOMPSON, 745 SOUTH 23RD STREET 2ND FLOOR, ARLINGTON, VA, 22202

(21) Appl. No.: 10/477,396

(22) PCT Filed: May 13, 2002
(86) PCT No.: PCT/GB02/02220

(30) Foreign Application Priority Data
May 11, 2001 (GB) 0111505.4

(51) Int. Cl. A61H 33/06

(52) U.S. Cl. 4/526

(57) ABSTRACT

A collapsible sauna cubicle comprising: a base (2), a roof (3), and at least one support member (4a,4b,4c,4d), wherein the or each support member is releasably connectable to the base at one end, and the roof at another end, and at least one wall member (5a,5b,5c,5d), the or each wall member being detachably mountable on at least one respective support member.

The present invention relates to a portable sauna. The term “sauna” as used herein is not limited to an apparatus that provides a dry heat environment, but is intended also to encompass an apparatus that can provide a steam or vapour environment for a person.

A portable sauna is a sauna that can be dis-assembled for transport or storage. One type of portable sauna is disclosed in UK patent application GB-A-2 195 530. This discloses a prefabricated sauna made from a front box portion and a rear box portion. The box portions are provided with releasable coupling-clamps to enable the two box portions to be connected to one another to form the sauna When it is desired to transport or store the sauna the first and second box portions are disconnected from one another to facilitate transport or storage of the sauna

This prior art sauna is, however, not satisfactory. Although the sauna can be split into two box portions, each box portion is still bulky and heavy, and is difficult to transport and store.

GB-A-2 195 530 discloses a further portable sauna, in which an enclosure is formed by joining four side panels, a roof and a base to one another. This prior art portable sauna is, however, difficult to assemble since a stable structure is not formed until all the side panels, the base and the roof have been connected to one another.

GB-A-2 241 165 discloses a further portable sauna, in which an enclosure is formed by joining a self-standing enclosure wall, a roof and a base to one another. This prior art portable sauna is, however, also difficult to assemble because of the difficulty of handling the self-standing enclosure wall. The self-standing enclosure wall is also bulky to store.

A first aspect of the present invention provides a sauna apparatus configurable in an assembled configuration and in a disassembled configuration, the apparatus comprising: a base; a roof; at least one support member, a first end portion of the or each support member being releasably connectable to the base and a second end portion of the or each support member being releasably connectable to the roof; and at least one wall member, the or each wall member being detachably mountable to at least one respective support member. The provision of the support member(s) makes assembly of the sauna easier than assembly of the sauna of GB-A-2 195 530. Moreover, a sauna of the invention is easier to assemble, disassemble and store than a sauna of GB-A-2 241 165, because the wall member(s) and the support member(s) are separate components.

In a preferred embodiment, the or each support member is adjustable in length.

Further preferred features of the invention are set out in the dependent claims.

Preferred embodiments of the present invention will now be described by way of illustrative example with reference to the accompanying figures in which:

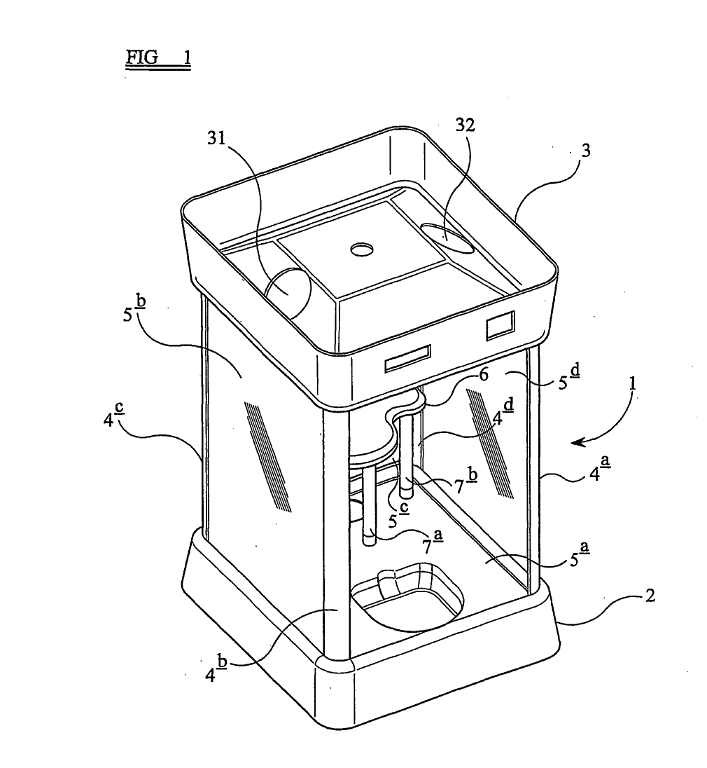

FIG. 1 is a perspective view of a sauna according to an embodiment of the present invention;

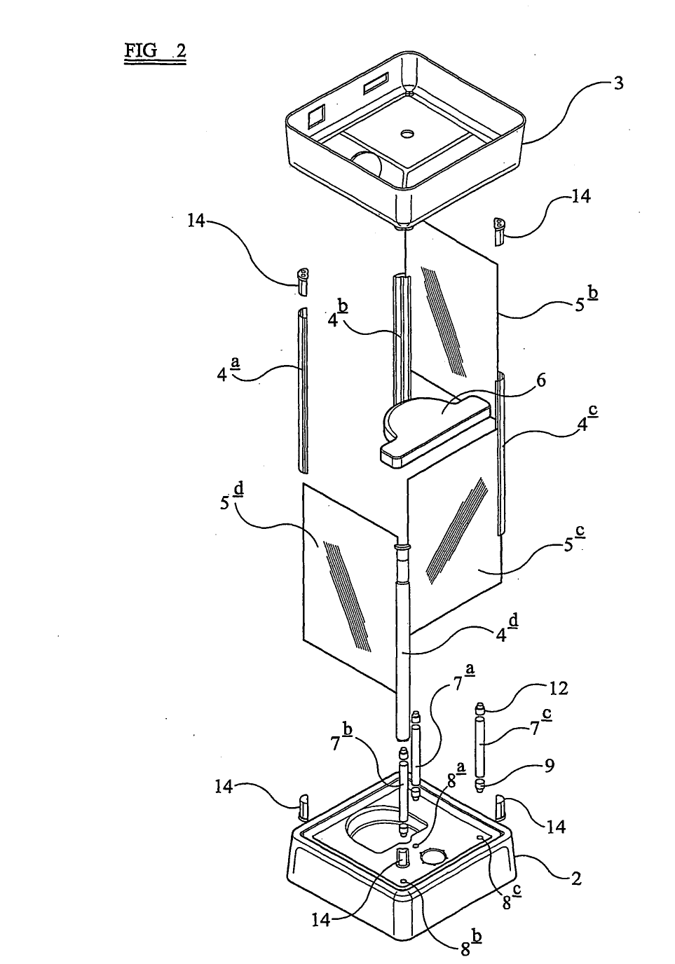

FIG. 2 is an exploded view of the sauna of FIG. 1;

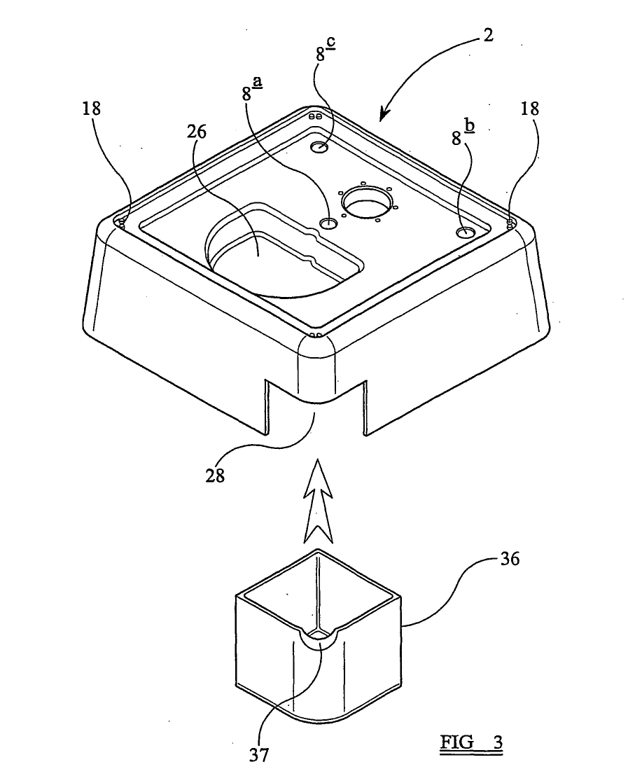

FIG. 3 is a perspective view of the base of the sauna of FIG. 1;

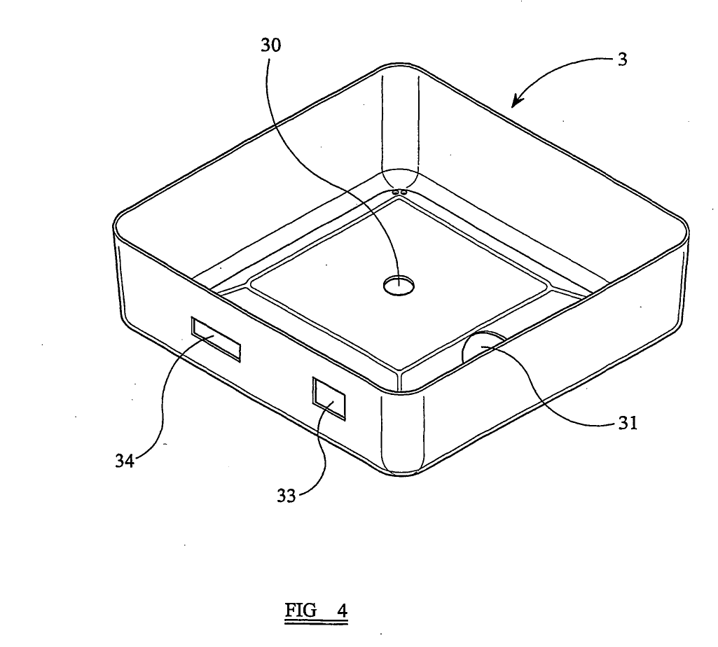

FIG. 4 is a perspective view of the roof of the sauna of FIG. 1;

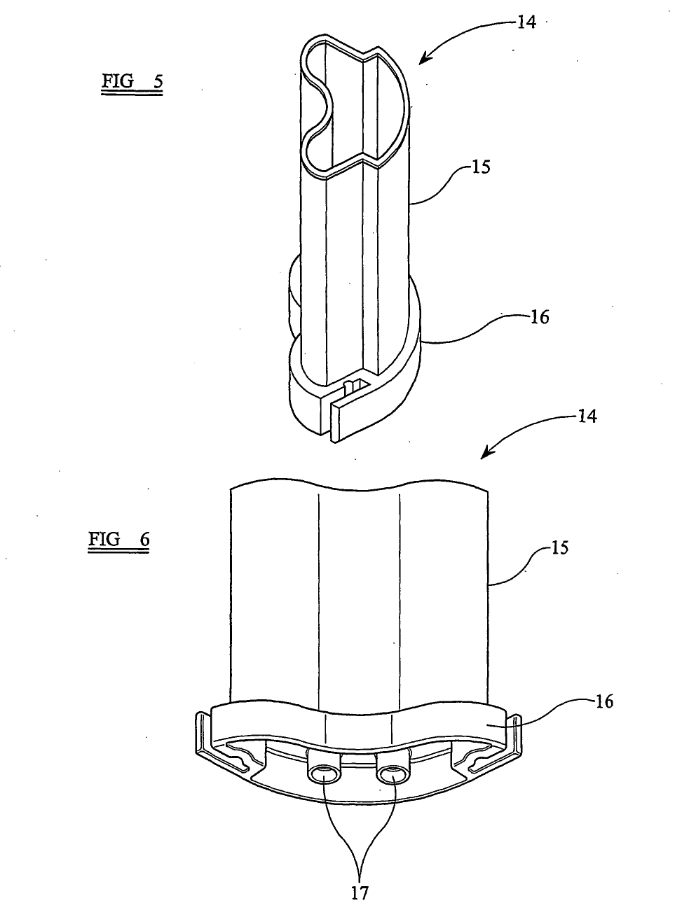

FIG. 5 is a perspective view of a locating means for a support member of the sauna of FIG. 1;

FIG. 6 is a perspective view from below of the locating member of FIG. 5;

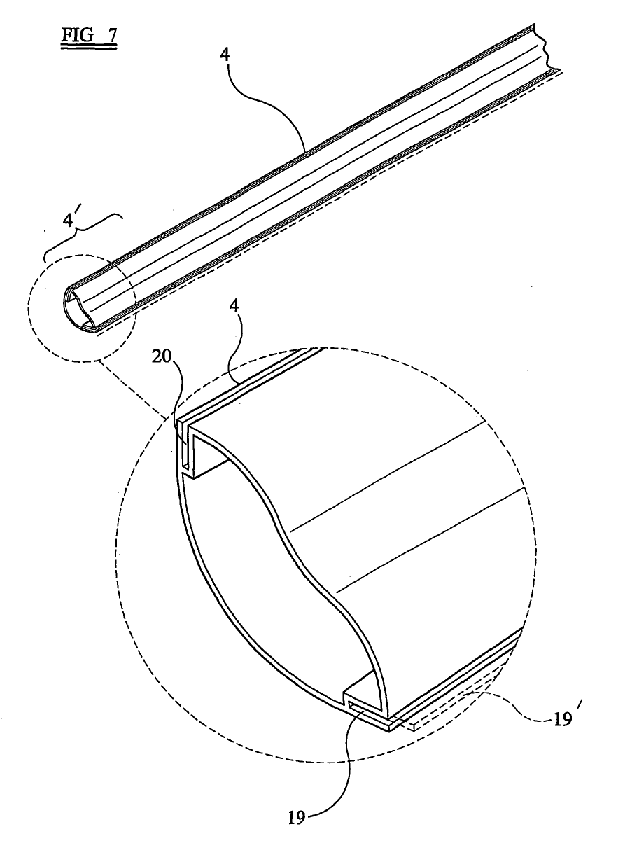

FIG. 7 is a partial perspective view of a support member of the sauna of FIG. 1;

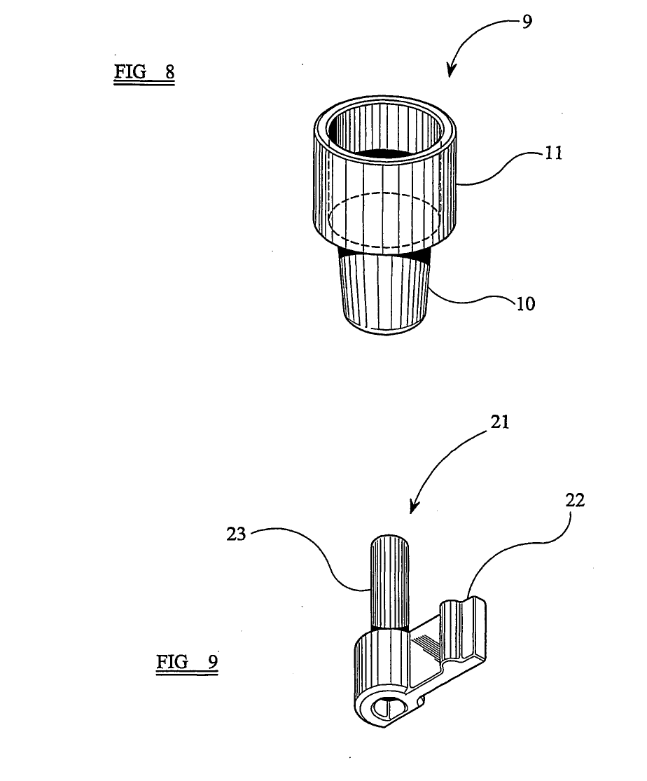

FIG. 8 is a perspective view of connecting member for a seat support leg;

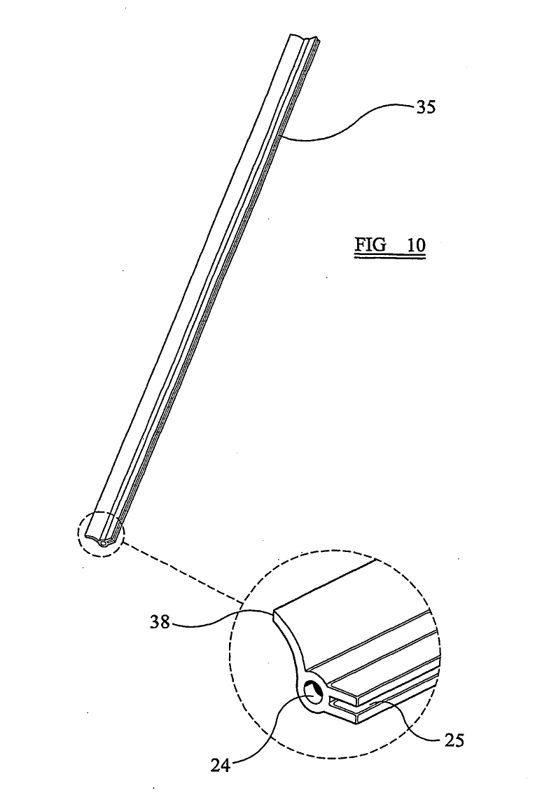

FIG. 9 is a perspective view of a door mounting member;

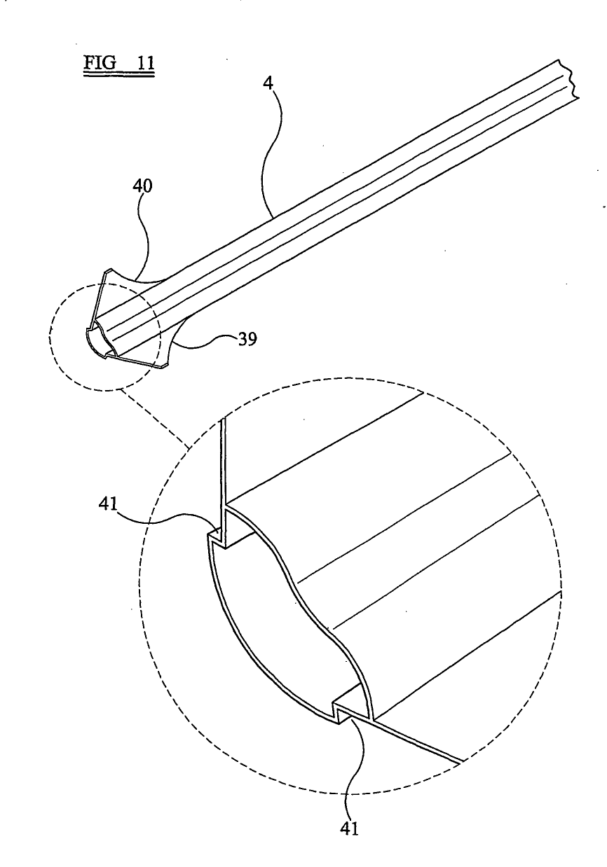

FIG. 10 a perspective view of a door mounting strip; and

FIG. 11 is a perspective view of another support member.

FIG. 1 is a perspective view of a sauna 1 according to an embodiment of the present invention, and FIG. 2 is a perspective exploded view of the sauna of FIG. 1. The sauna 1 comprises a base 2, a roof 3, and a plurality of support members 4a,4b,4c,4d. Four support members are provided in the embodiment shown in FIGS. 1 and 2, but fewer or more than four support members may be provided. The support members are releasably connectable to both the base 2 and the roof 3, so that the support members, base and roof can be detached from one another so as to disassemble the sauna for storage or transport. When the sauna is in its assembled configuration shown in FIG. 1, one end of each support member is connected to the base 2, and the other end of each support member is connected to the roof 3.

The sauna 1 of this embodiment further comprises a plurality of wall members or side panels 5a, 5b, 5c, 5d that form, with the roof 3 and base 2, an enclosure for retaining heat, vapour and/or steam. The side panels may be opaque, transparent or translucent, as desired. In the embodiment of FIG. 1 the left hand side panel 5b (as the sauna is seen in FIG. 1) has been shown as an opaque panel for illustrative purposes, while the remaining side panels have been shown as transparent. However, the invention is not limited to this particular arrangement, and any combination of transparent, opaque or translucent side panels can be used. One of the side panels is preferably mounted so that it can be moved between a first, open, position in which a user can enter or leave the sauna and a second, closed, position, so as to act as a door.

In the embodiment of FIGS. 1 and 2 the side panels 5a,5b,5c,5d are detachably mounted on the support members 4a,4b,4c,4d. The side panels that do not form the door (hereinafter referred to as “fixed side panels”) are mounted on two adjacent support members—as an example, one side edge of the side panel 5c is mounted on the support member 4d and the other side edge of the side panel 5c is mounted on the support member 4c. In principle, however, the fixed side panels could be attached to the base 2 and/or the roof 3 instead of, or as well as, to the support members 4a,4b,4c,4d. In principle it would also be possible for each fixed side panel to be mounted on only one support member.

One convenient way of mounting the side panels 5a,5b,5c,5d to the support members 4a,4b,4c,4d is for the side panels to be a clip fit into grooves provided in the support members, as will be described below. However, the invention is not limited to this particular method of mounting the side panels on the support members, and any suitable mounting method can be used.

The side panel that forms the door (hereinafter referred to as the “door panel”) is also mounted on one of the support members, in a manner described below.

The sauna is preferably provided with a seat on which the user of the sauna can rest. In the embodiment of FIG. 1, a seat 6 is provided. In FIG. 1 the seat 6 is supported by one or more seat support legs (three seat support legs 7a, 7b and 7c are shown in FIG. 1), but it could be supported in any suitable way, for example by attaching the seat to one of the side panels or to one or more of the support members.

One preferred arrangement for supporting the seat is illustrated in FIGS. 1 and 2, and in this arrangement apertures 8a, 8b and 8c are provided in the base of the sauna, one aperture for each seat support leg. As shown in FIG. 8, each foot member 9 has a spigot portion 10 that has an exterior cross-section that is complementary to the interior cross-section of the corresponding aperture in the base of the sauna In the embodiment of FIG. 1 and 2, a “foot member” 9 is disposed in each aperture in the base 2, and the lower end of each seat support leg is received in a respective foot member. Each foot member 9 has a “cup portion” 11 that receives a seat support leg. The interior of the cup-portion 11 of a foot member is preferably dimensioned so that a seat support leg is a push fit into the cup portion.

The seat 6 is connected to the seat support legs 7a,7b,7c by means of upper mounting members 12. These are generally similar to the foot member 9, and have a cup portion for receiving the upper end of a seat support leg and a spigot portion that locates into a complementary recess provide in the underside of the seat 6.

Each foot member 9 may be permanently attached to the base of the sauna, for example by means of an adhesive or, if the base and the foot members are both made of a plastics material, by fusing each foot member to the base. Alternatively, each foot member may be mounted on the base so as to be detachable from the base, for example by screwing each foot member to the base. Similarly, the upper mounting members 12 may be permanently attached to the seat or they may be mounted on the seat so as to be detachable from the seat.

In the embodiment shown in FIG. 1 and 2 the seat 6 is provide with three seat support legs. The invention is not limited to this particular number of seat support legs, however, and fewer or more than three seat support legs may be provided.

The support members 4a, 4b 4c,4d can in principle be connected to the base 2 and to the roof 3 in any way that (1) allows easy disassembly of the sauna and (2) provides a stable structure when the sauna is in its assembled configuration. A preferred method of connecting the support members to the base and to the roof is to provide each support member 4 with end portions 4′ having a hollow cross section, as shown in FIG. 7, and to provide complementary protrusions on the base 2 and roof 3. The support members can then be attached to the base 2 and roof 3 by placing one hollow end portion of a support member over a protrusion provided on the base and by placing the other hollow end portion of a support member over a protrusion provided on the roof.

In principle, the protrusions could be made integral with the base and the roof. For ease of fabrication, however, it may be preferred that the protrusions are not integral with the base 2 and roof 3 but are separate components. In the embodiment of FIGS. 1 and 2, the protrusions on the base and roof of the sauna are provided by connecting members 14 that are not manufactured integrally with the base and roof.

FIG. 5 and 6 show a connecting member 14 of this embodiment of the invention, and FIG. 7 shows a partial perspective view of a support member (denoted generally as “4”) with an enlarged view of an end portion. It will be seen that the connecting member 14 has a first portion 15 with an external cross section that is complementary to the internal cross section of the hollow end portion 4′ of the support member 4. Thus, the support member 4 can be connected to the connecting member 14 simply by placing the hollow end portion 4′ of the support member 4 over the first portion 15 of the connecting member. The portion 15 of the connecting member is preferably dimensioned so that the support member is a push fit onto the connecting member, since this allows for easy assembly and disassembly of the sauna, while providing a stable structure when the support member is in its assembled configuration. If desired, however, it may alternatively be arranged that the support member is a clip-fit onto the connecting member 14, for example by providing a sprung clip (not shown) on either the support member or the connecting member 14 for engagement with the connecting member or support member respectively. Alternatively, separate fastening means (not shown) can be provided for releasably fastening the support member to the connecting member 14, and these could be, for example, a screw, a nut and bolt etc.

A second part 16 of the connecting member has a larger cross section than the first part 15 of the connecting member. When the support member is placed onto the first portion of the connecting member 14, the end face of the support member will abut against the second portion 16 of the connecting member, thereby ensuring consistent location of the support member. For aesthetic reasons, it is preferred that the external cross-section of the second portion 16 of the connecting member is substantially the same as the external cross-section of the support member.

Where the connecting members 14 are separate components, they can be secured to the base or roof of the sauna by any suitable method. Each connecting member may be permanently attached to the base or roof of the sauna, for example by means of an adhesive or, if the connecting member and the base or roof are both made of a plastics material, by fusing each connecting member to the base or roof. Alternatively, each connecting member may be mounted on the base or roof so as to be detachable from the base or roof, for example by screwing each connecting member to the base or roof.

In one embodiment of the invention, one or more cylindrical protrusions 17 are provided on the underside of the connecting member 14 and complementary protrusions 18 are provided on the base 2 and roof 3. Each protrusions 18 locates into the interior of a corresponding one of the cylindrical protrusions 17 on the underside of the connecting member 14 when the connecting portion is disposed on the base or roof, and this ensures the correct positioning of the connecting members.

In an alternative embodiment (not illustrated), apertures are provided in the base 2 and roof 3 in place of the protrusions 18. In this embodiment it is possible to pass a suitable fasting member such as, for example, a screw through each aperture in the base or roof so as to engage in the corresponding cylindrical protrusion 17 in the connecting member 14 thereby securing the connecting member 14 to the base or roof.

The support member is provided with a second hollow end portion at its other end (not shown in FIG. 7). This enables the other end of the support member to be attached to another connecting member 14—so that one end of the support member may be attached to the base of the sauna and the other end of the support member may be attached to the roof of the sauna. The central portion of the support member, between the two hollow end portions, is not required to be hollow. However, the support member is conveniently provided with a hollow cross-section along its entire length, since this enables the support member to be manufactured by an extrusion process.

FIG. 7 shows the cross-section of a support member. It will be seen that the support member is provided with two longitudinal grooves 19, 20. In FIG. 7 the grooves extend at substantially 90° to one another, and this support member is suitable for use in a sauna having a rectangular cross-section. The side edges of the fixed side panels 5a, etc locate in the groves 19, 20 of the support members, and this provides an easy and reliable method of fastening the fixed side panels to the support members.

It is desirable for the joint between a side panel and a support member to be watertight or substantially watertight. A water-tight or substantially water-tight joint maybe provided by making the width of the grooves 19, 20 in the support member slightly less than the thickness of the side panels, so that inserting a side panel in one of the grooves 19,20 causes the support member to deform slightly and thereby grip the side panel tightly. Alternatively, if the width of the grooves 19, 20 in the support member is greater than the thickness of the side panels, a gasket may be inserted into a groove 19,20 to provide a water-tight seal between the support member and the side panel inserted into the groove.

As noted above, it is desirable that one side panel of the sauna forms a door. The support member adjacent the opening edge of the door panel is preferably provided with a lip 19′, as shown in broken lines in the insert of FIG. 7, so that the door panel can abut against the lip when closed. It is not necessary to provide the lip 19′ on other support members, although this can be done if it desired for all support members to have the same cross-section for ease of manufacture.

One method for the assembly of the sauna of FIGS. 1 and 2 will now be described.

Initially, the connecting members 14 are secured to the base 2 and to the roof 3. (This step is omitted if the connecting members have been attached to the base and roof during the manufacturing process.) Next, one support member 4a is attached to the base, by pushing one end of this support member onto a connecting member provided on the base 2 so that the reduced cross-section portion 15 of the connecting member is received in one hollow end portion of the support member. The remaining support members 4b, 4c, 4d are then attached to the base in a similar way, by pushing one end of each support member onto a respective connecting member 14.

One of the fixed side panels is then attached to the thus-formed “frame”. This may be done by locating one edge of the side panel into a groove 19 in one support member and locating the other edge of the side panel into the opposing groove in an adjacent side member, and sliding the side panel into position. The second and third fixed side panels are then attached in the same way. For convenience of assembly, it is preferable for the part-assembled sauna to be tilted or placed with one side on the floor or ground during these steps.

The pivot members 21 (described below with reference to FIG. 9) for the door panel are then attached to one support member, by locating them in one of the grooves of that support member.

The roof 3 is then attached to the support members, to complete the sauna enclosure. This may be done by bringing the roof 3 towards the part-assembled sauna so that the reduced cross-section portion 15 of each connecting member 14 provided on the underside of the roof is received in the other hollow end portion of a respective support member.

The seat 6 may be assembled at any convenient time in the assembly process. This is done by disposing the spigot portion 10 of each of the foot members into a respective aperture 8a, 8b, 8c in the base, and locating one seat support leg 7a, 7b, 7c into each foot member (unless the foot members have been manufactured integrally with the base, or have been attached to the base during the manufacturing process). The upper mounting members 12 are attached to the underside of the seat 6 (unless they have been manufactured integrally with the base, or have been attached to the base during the manufacturing process). The seat 6 is then disposed in position so that the upper end of each seat support member is received in a respective upper mounting member 12.

One convenient way of mounting one side panel so that it can be opened is to use a pivot member 21 as shown in FIG. 9. The pivot member 21 of FIG. 9 contains a support portion 22 that is dimensioned to be a push-fit into one of the grooves 19, 20 of a support member. The pivot member 21 is also provided with a projecting spigot 23.

Two or more pivot members 21 can be mounted in a groove of one of the support members, and a side panel can be mounted on the spigots 23 of the pivot members so that the side panel forms a door into the sauna.

FIG. 10 illustrates a support strip 35 that can be used to mount the door panel on the pivot members of FIG. 9. Each end of the support strip 35 is provided with a bore 24, that can receive the spigot of a pivot member 21. The support strip 35 is also provided with a groove 25, that can receive a side panel in the manner described above for the grooves 19, 20 of the support portions 4a,4b,4c,4d. The support strip 35 is attached to one side edge of the door panel. Two pivot members 21 are mounted on the corresponding support member, by locating the support portion 22 of each pivot member into one of the grooves 19, 20 of the support member. One pivot member is mounted at or near the lower end of the support member with its spigot directed upwards, and the other pivot member is mounted at or near the upper end of the support member with its spigot directed downwards. The support strip is mounted so that the spigots of the pivot members engage in the bore 24 of the support strip, thereby allowing the support strip to rotate about the spigots of the pivot members.

The support strip 35 is preferably provided with a lip 38 that is shaped and dimensioned so as to come into contact with the support member on which the door panel is mounted when the door is closed. This lip acts as a seal, and helps to retain steam/heat within the sauna enclosure.

The length of the support strip 35 is preferably less than the height of the door panel, to allow for the height of the pivot members 21. The door panel may also need to be shaped so as to clear the pivot members, to allow the door panel to close. The width of the door panel should be such that the panel can open freely, and may be less than the width of the fixed panels. The edges of the door panel, other than the edge provided with the support strip 35, are preferably provided with a capping strip for protection against damage, and also for sealing when the door panel is closed.

The sauna is preferably provided with a means for holding the door panel shut, for example a magnetic catch. Alternatively the door panel may be provided with a sprung clip that engages in a corresponding groove provided in the support portion when the door panel is closed.

The sauna may be disassembled by a process reverse to the assembly process described above. That is, initially the roof 3 would be detached from the support members. The side panels would then be detached from the support members, and the support members would then be detached from the base. If desired (and if possible) the connecting members 14 could be detached from the base and the roof.

FIG. 3 shows the base 2 of the sauna of this embodiment of the invention. A recess 26 is provided in the base of the sauna, and this recess may accommodate, for example, a foot spa (not shown) or other foot relaxation equipment such as, for example, a vibrating plate for massaging the feet of a user of the sauna.

The recess 26 is preferably provided with a cover (not shown) that can cover the recess 26 if desired, for example, if the user of the sauna does not wish to use a foot spa. The provision of the cover will also aid entering and leaving the sauna, since closing the recess 26 with the cover will make it easier for a person to enter or leave the sauna The cover is preferably made strong enough to bear the weight of a user of a user of the sauna. When the cover closes the recess it is preferably flush, or nearly flush, with the upper surface of the base of the sauna, to eliminate the risk of a person tripping.

The cover may be operated manually, and may be provided with a handle to allow a user of the sauna to move the cover easily. The handle preferably comprises a recess in the upper surface of the cover, since this will not provide any obstruction to a user when the recess is closed by the cover.

For greater ease of use, the cover may preferably be provided with actuating means, such as a motor, to enable remote opening and closing of the cover. Thus a person can enter the sauna with the cover closing the recess, and once they have settled they can operate the actuating means to move the cover and open the recess.

A sauna requires means for introducing heat, steam or aromatic vapour into the sauna enclosure. A sauna of the present invention is therefore preferably provided with internal heat and/or steam and/or vapour generating equipment although, in principle, an external heat/steam/vapour generating means could be used to supply heat/steam/vapour to the sauna enclosure. In a preferred embodiment of the invention, a steam kettle (not shown) is provided within the base 2 of the sauna to provide steam and/or aromatic vapour. Alternatively, or additionally, heating elements (not shown) can be provided within the base 2 to generate dry heat. An aperture 27 is provided in the base to allow steam/vapour from a steam kettle provided within the base to enter the enclosure.

In a further embodiment, the sauna is provided only with appropriate mountings and connections for a steam kettle, heating element etc. This allows the purchaser to equip the sauna as they wish.

The base 2 is preferably provided with a drip tray 36 to collect any water that condenses on the interior of the enclosure, as shown in FIG. 3. Where a drip tray is provided, the base is preferably provided with an aperture 28 to enable the drip tray to be removed for emptying, and drainage holes (not shown) are provided in the base to allow water to drain into the drip tray. The drip tray is preferably provided with a spout 37 to allow easy emptying of the drip tray.

FIG. 4 is a schematic perspective view of one embodiment of a roof of a sauna of the invention. In use, lighting (not shown), such as low-voltage lighting, can be disposed in the roof for illuminating the interior of the sauna In the roof shown in FIG. 4, one aperture 30 for a light source is shown, but more than one aperture for light sources could be provided if desired.

A sound system may also be provided in the roof 3 for use by a user of the sauna. Apertures 31, 32 are provided in the roof of FIG. 4 for receiving loud speakers of a stereo sound system, although apertures for only one loudspeaker, or for more than two loudspeakers, could alternatively be provided. A further aperture 33 is provided in the edge of the roof, for receiving a control unit for the stereo system. A user is able to pre-select, for example, a desired radio channel or a desired sound recording before entering the sauna

A control unit for controlling the operation of the sauna may also be provided in the roof 3. The control unit is electrically connected to the heat/steam generator, so that a user can pre-select, for example, a desired temperature or a desired duration. An aperture 34 is provided in the roof of FIG. 4 for receiving the control unit. In addition to controlling the heat/steam/vapour generating means, the control unit can also control the lighting system provided in the sauna. The control unit could also be used to control the sound system, in which case a separate control unit for the sound system is not required.

In order to facilitate making electrical connections between the control unit and equipment mounted in the base 23 of the sauna when the sauna is assembled it is preferable that the electrical leads from the control unit terminate in an electrical connector such as, for example, one part of a conventional “plug and socket” connector, and that the electrical leads from equipment mounted in the roof of the sauna terminate in a similar connector. Leads are provided in one of the support members, and these terminate at each end in complementary electrical connectors. During the process of attaching the support member provided with the electrical leads to the base of the sauna, the leads from the equipment mounted in the base are connected to one end of the leads provided in the support member. Similarly, during the process of attaching the support member provided with the electrical leads to the roof of the sauna, the leads from the control means are connected to the other end of the leads provided in the support member, thereby electrically connecting the equipment mounted in the base of the sauna to the control means.

A sauna of the invention may be made from any suitable materials. In a preferred embodiment the sauna is made from plastics materials. The side panels 5a,5b,5c,5d are preferably made from a polycarbonate material/Lexan, and other components can be made from ABS plastics materials. As noted above, the support members 4a,4b,4c,4d can conveniently be made by an extrusion process, and other components can be made by vacuum forming or injection moulding.

A sauna of the present invention can be used at home, or it can be used in commercial applications such as at a sports club. Where the sauna is intended for commercial use, it can be provided with a meter such as, for example, a coin-operated, token-operated or magnetic-card operated meter so that the owner or operator or the sauna can readily collect payment from users of the sauna. The meter, for example, be interlocked with the heat, steam or vapour generating apparatus of the sauna, so that no heat, steam or vapour is generated until a user has inserted a coin, token or magnetic card into the meter. Once a user has inserted a coin, token or card into the meter, the heat, steam or vapour generating means will operate for a pre-determined period. Alternatively, the door of the sauna may be provided with a lock that is interlocked with the meter, so that the door remains locked until the user inserts a coin, token or card into the meter.

The sauna of the invention is not limited to the preferred embodiments described above, and may be varied in many ways. For example, in the embodiment described above, the sauna is provided with four support members 4a, 4b, 4c, 4d and has a substantially rectangular cross-section. The invention is not, however, limited to this. The sauna could have more or fewer than four support members, and the cross-section of the sauna need not be rectangular. In the embodiments described above the sauna is intended to accommodate one person, but it is possible to apply the invention to a larger sauna that will accommodate two or more people.

The invention is not limited to the particular arrangement described above for mounting the support members 4 to the base and roof, and any suitable mounting arrangement may be used. For example, the support members could simply be fitted into apertures or recesses provided in the base and roof In this modified embodiment the apertures or recesses in the base and roof may be dimensioned so that each support member is a push-fit into the respective recess or aperture. Additionally or alternatively, clips may be provided on the base and roof, and/or on the support members, so that each support member is a clip fit into the base or roof.

In an embodiment in which the support members fit into apertures or recesses provided in the base and roof, the support embers could have a solid cross section over their entire length and it is not necessary for the support members to have the portions 4′ of hollow cross-section at their ends. (It should be noted, however, that it may be preferable for at least one support member to have a hollow cross-section throughout its entire length, since this allows electrical leads running from the base to the roof to be fed through the interior of the support member.)

The support members may be provided with a fairing 39,40 at one or both ends, as shown in FIG. 11. In an embodiment in which the support members fit into a recess or aperture in the base and/or roof, the aperture is provided with a complementary cross-section so that the fairing can be accommodated within the recess or aperture. In addition to improving the appearance of the sauna, the fairing also provides rigidity to the assembled sauna since it ensures that the support members remain substantially perpendicular to the base and roof.

In FIG. 7 the support members are provided with grooves 19, 20 for receiving the fixed side panels. The invention is not limited to this, however, and the side panels may be secured to the sauna in any suitable manner. For example, the support members may be provided with stepped recesses 41 as shown in FIG. 11 for receiving the side panels, rather than with the grooves 19, 20. In this embodiment the side panels may be mounted from outside once the basic structure of the sauna has been assembled, and this may be an easier assembly method than the above-described method of sliding the fixed side panels into the grooves 19, 20 of FIG. 7. (It should be noted that any support member suitable for a sauna of the invention may be provided with the stepped recesses 41, not just the faired support member of FIG. 11. Conversely, the faired support member of FIG. 11 may be provided with any suitable means for securing the side panels.)

A side panel may be held in place in a stepped recess 41 by any suitable means. For example, the side panels may be simply screwed to the support members. Alternatively, a side panel may be retained in position by a retaining strip (not shown) that is attached to the support member.

The recess for accommodating a foot spa or other foot relaxation apparatus is not restricted to use in a sauna apparatus of the present invention. In principle, a recess for accommodating a foot spa or other foot relaxation apparatus could be incorporated in a sauna of any conventional design.

In the embodiments described above, the support members 4a, 4b, 4c, 4d have a fixed length. In an alternative embodiment of the invention, the support members are not fixed in length, but are adjustable in length. This enables the length of a support member to be reduced when the sauna has been disassembled, so the space required to store the sauna is reduced. It also enables the height of the sauna to be adjusted, for example where it is desired to use the sauna in a room having a low ceiling.

One convenient way of making the length of the support members adjustable is to make the support members telescopic. That is, each support member would be formed of at least first and second parts, with the first part having a hollow cross-section and having internal dimensions greater than the external dimensions of the second part of the support member. The second part of the support member could then slide inside the first part of the support member, thereby adjusting the overall length of the support member.

Alternatively, each support member may comprise two or more sections that can be separated from one another when the sauna is disassembled, so as to facilitate storage or transport. One section may be a push fit or a clip fit into the other section, so that the support embers may be easily re-assembled when it is desired to assemble the sauna.

In a further embodiment a supply of oxygen gas may be provided within the sauna This can conveniently be done by disposing a source of oxygen gas at above atmospheric pressure outside the sauna, and connecting the source of oxygen gas to a mask inside the sauna, for example using a flexible tube. This enables a user of the sauna to breathe air enriched with oxygen gas, or even to breathe substantially pure oxygen gas, within the sauna. A switch for controlling the supply of oxygen through the aperture can be provided, preferably within the sauna

1. A sauna apparatus configurable in an assembled configuration and in a disassembled configuration, the apparatus comprising: a base; a roof; at least one support member, a first end portion of the or each support member being releasably connectable to the base and a second end portion of the or each support member being releasably connectable to the roof; and at least one wall member, the or each wall member being detachably mountable to at least one respective support member.

2. A sauna apparatus as claimed in claim 1 wherein the or each support member is adjustable in length.

3. A sauna apparatus as claimed in claim 1 or 2 wherein the base is provided with first connecting means for releasably connecting the or each support member to the base.

4. A sauna apparatus as claimed in claim 3 wherein the first connecting means comprises one or more protrusions provided on the base, and wherein the first end portion of the or each support member is hollow and has an internal cross-section that is complementary to the external cross-section of the associated protrusion.

5. A sauna apparatus as claimed in any preceding claim wherein the base is provided with second connecting means for releasably connecting the or each support member to the roof.

6. A sauna apparatus as claimed in claim 5 wherein the second connecting means comprises one or more protrusions provided on the roof, and wherein the second end portion of the or each support member is hollow and has an internal cross-section that is complementary to the external cross-section of the associated protrusion.

7. A sauna apparatus as claimed in claim 4 or 6 wherein the or each support member is a push-fit onto the associated protrusion.

8. A sauna apparatus as claimed in claim 4 or 6 wherein the or each support member is a clip-fit onto the associated protrusion.

9. A sauna apparatus as claimed in any preceding claim wherein the or each support member is provided with at least one recess for receiving a side panel.

10. An apparatus as claimed in any preceding claim wherein a support member is provided with mounting means for mounting a side panel such that the side panel is movable between a first position in which a person can enter or leave the sauna and a second position.

11. An apparatus as claimed in claim 10 when dependent from claim 9 wherein a first portion of the mounting means is received in the recess of the support member thereby to releasably fasten the mounting means to the support member.

12. An apparatus as claimed in any preceding claim wherein a recess in defined in the base of the apparatus.

13. A sauna apparatus configurable in an assembled configuration and in a disassembled configuration, wherein a recess in defined in the base of the apparatus in its assembled configuration.

14. An apparatus as claimed in claim 12 or 13 and further comprising a removable cover for the recess.

15. An apparatus as claimed in claim 14 and further comprising actuating means for moving the cover between a first position in which it closes the recess and a second position.

16. An apparatus as claimed in claim 15 wherein the actuating means is disposed within the base.

17. An apparatus as claimed in any of claims 12 to 16 and further comprising a footspa receivable in the recess in the base of the sauna.

18. An apparatus as claimed in any of claims 12 to 16 and further comprising a foot massaging apparatus receivable in the recess in the base of the sauna.

19. An apparatus as claimed in any preceding claim and further comprising means for supplying oxygen gas at above atmospheric pressure to the interior of the apparatus.
